(19) United States
(12) Patent Application Publication
(10) Pub. No.: US 2004/0145176 A1
(43) Pub. Date: Jul. 29, 2004

(54) Sheet material pad

(76) Inventor: Amar G. Bose, Wayland, MA (US)

Correspondence Address: SATOWCLAYTONL, 12 Pleasantview Terrace, Framingham, MA, 01701, US

(21) Appl. No.: 10/702,371

(22) Filed: Nov. 6, 2003

Related U.S. Application Data
(63) Continuation of application No. 10/353,531, filed on Jan. 29, 2003, now abandoned.

(51) Int. Cl. B42D 1/00

(52) U.S. Cl. 281/38

(57) ABSTRACT

A pad of sheet material including a first plurality of sheets, each sheet having on a portion of a surface a releasable adhesive and a second plurality of sheets having both surfaces substantially free of adhesive.

This application is a continuation of U.S. Pat. App. 10/353,531, filed Jan. 29, 2003, now abandoned.

### BACKGROUND OF THE INVENTION

The invention relates to assemblages of sheet materials, and more particularly to pads of sheet materials.

### BRIEF SUMMARY OF THE INVENTION

It is an important object of the invention to provide an improved pad of sheet material, such as paper.

According to the invention, a pad of sheet material includes a first plurality of sheets, each sheet having on a portion of a surface an adhesive and a second plurality of sheets having both surfaces substantially free of adhesive.

In another aspect of the invention, a pad of sheet material includes a plurality of sheets of sheet material, each sheet removably attached to an adjacent sheet. A first portion of the plurality each has a pressure sensitive adhesive on a surface; and a second portion of the plurality has both surfaces essentially free of adhesive.

In still another aspect of the invention, a stack of sheet material includes a plurality of sheets and a holding structure, for collectively holding the plurality of sheets. The plurality of sheets has a first portion of sheets, each of which has on a surface a pressure sensitive, releasable adhesive, and a second portion, each of which is substantially free of adhesive.

Other features, objects, and advantages will become apparent from the following detailed description, which refers to the following drawings in which:

### BRIEF DESCRIPTION OF THE DRAWINGS

FIG. 1 is a cross sectional view of a pad of sheet material according to the invention; and

FIG. 2 is a cross sectional view of a second embodiment of the invention.

### SPECIFICATION

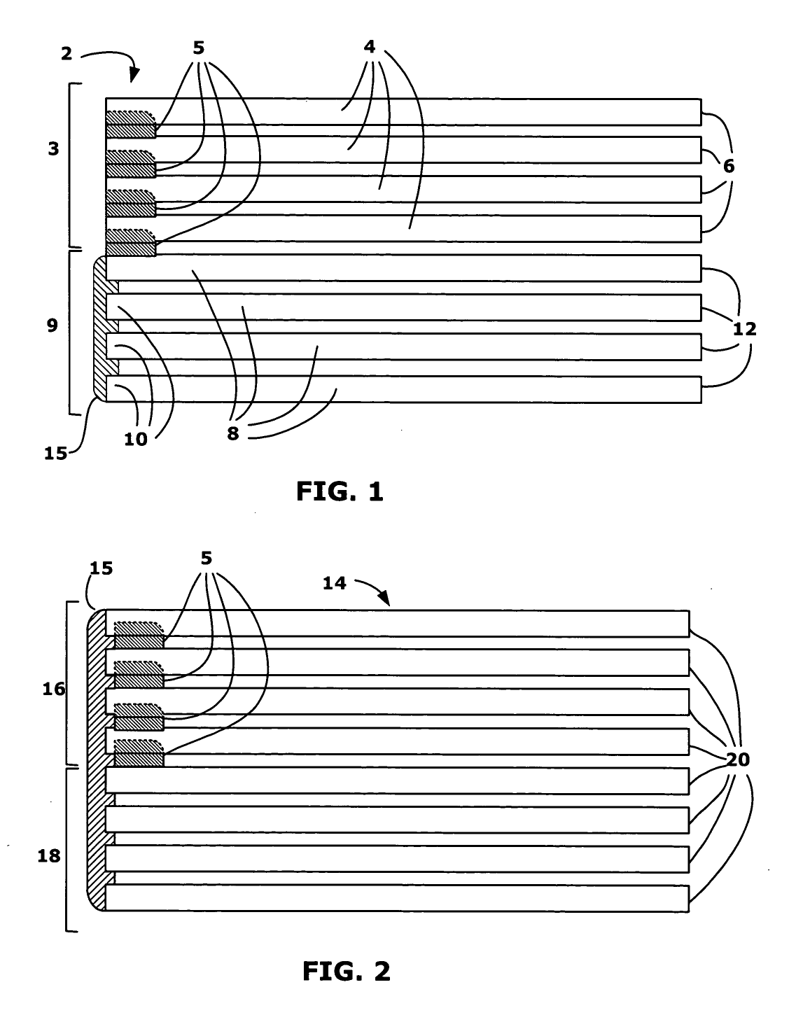

With reference now to the drawings and more particularly to FIG. 1, there is shown a pad 2 of sheet material according to the invention. A pad 2 of sheet material includes a first section 3 having plurality of sheets 4, each having on a portion of the lower surface a releasable, pressure sensitive adhesive 5, such that each of the sheets adheres to the sheet below it. On each sheet there is an edge 6 that has no adhesive so that each sheet 4 is removable from the sheet below it by grasping the unadhered edge 6 and pulling the sheet away from the pad. The removed sheet can then be subsequently adhered to a surface by placing the adhesive coated portion of the sheet against the surface and applying pressure. The adhesive is further formulated and applied such that the adhesive remains on the removed sheet, but little adhesive residue is left in the sheet below. Sheet material sheet and adhesive structures having the above properties can be made by many methods, such as using adhesives that “wick” into the sheet material fibers (as indicated by the dotted lines in FIG. 1) at high temperatures but that have relatively low adhesion at room temperatures. An example of a suitable sheet material with a suitable adhesive is the self stick removable notes marketed under the “Post-it®” trademark by 3M Corporation of St. Paul, Minn.

Pad of sheet material 2 includes a second section 9 that has a plurality of sheets 8 that are removably held together along an edge by an encapsulant 15 that encapsulates a small portion of edge 10 of sheets 8 such that individual sheets can be removed from the pad by grasping a non-encapsulated edge 12 and pulling away from the pad. Once removed from the pad, sheets 8 are non-adhesive, because the encapsulant may be non-adhesive at room temperatures or after curing, or because only a very small amount of encapsulant remains on the edge of the removed sheet of sheet material, or both.

To allow a user to more easily distinguish between first section 3 and second section 9, some visual distinguishing feature may be added, such as making the two sections of different colored sheet material, or by coloring the edges of the two sections differently from each other.

Referring to FIG. 2, there is shown a second embodiment of the invention. In the embodiment of FIG. 2, the sheets of a pad 14 of sheet material are removably held together along an edge by an encapsulant 15. The sheets of a first section 16 of the pad have on a portion of the lower surface a releasable, pressure sensitive adhesive similar to the first section 3 of FIG. 1, as described in the corresponding portion of the disclosure. The sheets of a second section 18 of the pad have essentially no adhesive on either surface. As with the embodiment of FIG. 1, the sheets of pad 14 each have an unadhered and unencapsulated edge 20. Individual sheets can be separated from the pad by grasping an unadhered and unencapsulated edge 20 and pulling away from the pad. Once separated from the pad, sheets from first section 16 may be subsequently re-adhered, repeatedly if desired, to a surface by placing the sheet against the surface and applying pressure. Once separated from the pad, sheets from second section 18 are non-adhesive.

In the embodiments of FIGS. 1 and 2, the encapsulant may be replaced by some other attachment medium or device allowing removal of individual sheets, such as a so-called “spiral binding” or other type of binding.

A pad of sheet material according to the invention is advantageous over conventional pads of sheet material because a user is given the choice of two types of sheet material, adhesive backed, or non-adhesive backed in a single pad of sheet material. Adhesive backed sheets can be used if the sheet is to be subsequently adhered to a surface, and non-adhesive backed sheets can be used where the adhesive backing is unnecessary or undesirable, such as if a note is to be placed in a pocket. The invention is most conveniently applied to paper, but can be applied to other sheet materials, such as foils, plastics, fabric or the like.

It is evident that those skilled in the art may now make numerous uses of and departures from the specific apparatus and techniques disclosed herein without departing from the inventive concepts. Consequently, the invention is to be construed as embracing each and every novel feature and novel combination of features disclosed herein and limited only by the spirit and scope of the appended claims.

What is claimed is:

1. (new) A pad of sheet material, comprising:
a first plurality of adjacent sheets, each sheet having on a portion of a surface a releasable adhesive so that each of said first plurality of sheets is adhered to another of said first plurality of sheets; and
a second plurality of adjacent sheets having both surfaces substantially free of adhesive

2. (new) A pad of sheet material in accordance with claim 1, wherein said second plurality of sheets are removably attached to another of said second plurality of sheets.

3. (new) A pad of sheet material in accordance with claim 2, wherein each of said said second plurality of sheets are each removably attached to said another of said sheets by edge encapsulation.

4. (new) A pad of sheet material in accordance with claim 1, wherein each of said second plurality of sheets are each removably attached to said another of said sheets by a binding structure.

5. (new) A pad of sheet material in accordance with claim 1, further comprising a first indicator for identifying said first adjacent plurality and a second indicator for identifying said second adjacent plurality of sheets.

6. (new) A pad of sheet material in accordance with claim 5, wherein said first indicator is a first color of the edges of said first adjacent plurality of sheets and said second indicator is a second color of the edges of said second adjacent plurality of sheets.

7. (new) A pad of sheet material, comprising:
a plurality of sheets of sheet material, each sheet removably attached to an adjacent sheet, comprising;
a first portion of consecutive sheets each having a pressure sensitive adhesive on a surface so that each of said first portion is adhered to an adjacent one of said portion; and
a second portion of said consecutive sheets having both surfaces substantially free of adhesive.

8. (new) A pad of sheet material in accordance with claim 7, wherein said each of said plurality of sheets is removably attached to said adjacent sheet by edge encapsulation.

9. (new) A stack of sheet material, comprising:
a plurality of sheets;
a holding structure, for collectively holding said plurality of sheets;
said plurality of sheets having a first portion of adjacent sheets, each sheet of said first portion having on a surface a pressure sensitive, releasable adhesive so that each of said first portion is releasably adhered to another of said first portion, and a second portion of adjacent sheets, each sheet of said second portion being substantially free of adhesive.

10. (new) A stack of sheet material in accordance with claim 9, wherein said holding structure comprises an encapsulant.

11. (new) A stack of sheet material in accordance with claim 9, wherein said holding structure comprises a binding structure.

12. (new) A stack of sheet material in accordance with claim 9, further comprising a first indicator for identifying said first portion and a second identifier for identifying said second portion.

13. (new) A stack of sheet material in accordance with claim 12, wherein said first identifier is a first color of the edges of said first portion and said second identifier is a second color of the edges of said second plurality of sheets.
